(19) United States
(12) Patent Application Publication
(10) Pub. No.: US 2024/0120462 A1
(43) Pub. Date: Apr. 11, 2024

(54) RECHARGEABLE LITHIUM BATTERY INCLUDING HYBRID NEGATIVE ELECTRODE AND HIGH CONCENTRATION ELECTROLYTE

(71) Applicants: UNIST(ULSAN NATIONAL INSTITUTE OF SCIENCE AND TECHNOLOGY), Ulsan (KR); KOREA ADVANCED INSTITUTE OF SCIENCE AND TECHNOLOGY, Daejeon (KR)

(72) Inventors: Nam-Soon CHOI, Ulsan (KR); Sewon PARK, Ulsan (KR); Seunghee HAN, Ulsan (KR)

(21) Appl. No.: 18/482,540

(22) Filed: Oct. 6, 2023

(30) Foreign Application Priority Data
Oct. 7, 2022 (KR) 10-2022-0128377

(51) Int. Cl. H01M 4/133; H01M 4/36; H01M 4/587; H01M 4/62; H01M 10/0525; H01M 10/0567; H01M 10/0568; H01M 10/0569

(52) U.S. Cl. CPC H01M 4/133; H01M 4/366; H01M 4/587; H01M 4/62; H01M 10/0525; H01M 10/0567; H01M 10/0568; H01M 10/0569; H01M 2004/027

(57) ABSTRACT

A rechargeable lithium battery includes a positive electrode, a negative electrode, a separator between the positive electrode and the negative electrode, and an electrolyte, wherein the negative electrode includes a negative electrode current collector and a negative electrode active material layer on the negative electrode current collector, the negative electrode active material layer includes a carbon material capable of intercalating and deintercalating lithium as a negative electrode active material, the negative electrode further includes a lithiophilic element on the surface of the negative electrode current collector and/or inside the negative electrode active material layer, the lithiophilic element includes one or more elements selected from Al, Ag, Au, Bi, In, Mg, Pd, Pt, Si, Sn, and Zn, the negative electrode is one in which lithium is electrodeposited between the negative electrode current collector and the negative electrode active material layer and/or inside the negative electrode active material layer by charging.

### CROSS-REFERENCE TO RELATED APPLICATION

This application claims priority to and the benefit of Korean Patent Application No. 10-2022-0128377 filed in the Korean Intellectual Property Office on Oct. 7, 2022, the entire contents of which are incorporated herein by reference.

### BACKGROUND OF THE INVENTION

### (a) Field of the Invention

A rechargeable lithium battery containing a hybrid negative electrode and a high-concentration electrolyte are disclosed.

### (b) Description of the Related Art

Rechargeable lithium batteries have achieved commercial success as a power source for portable electronic products and have successfully entered the power tool market. In addition, as the electric vehicle and power storage system markets are growing rapidly every year, the battery market is also expanding day by day. In this battery market, in order to secure a technological competitive advantage, it is necessary to secure characteristics such as high energy density, high output, safety, and long cycle-life.

As of 2021, electric cars can secure a driving distance of about 400 km to 500 km per charge, but there is a problem that it takes a long time to charge compared to a refueling time of cars with internal combustion engines. Therefore, it is necessary to reduce the number of charges through increased energy density of the battery and to reduce the charging time through rapid charging characteristics of the battery.

Graphite, which is widely used as a negative electrode material for a rechargeable lithium battery, has a theoretical capacity of 372 mAh/g, but since it currently implements a capacity of over 360 mAh/g, graphite itself has reached its limit. Therefore, additives such as silicon with high theoretical capacity are being used, but only a small amount is applied due to the problem of volume expansion.

Lithium metal has a high theoretical capacity of 3860 mAh/g and the lowest reduction potential (−3.04 V vs. H/H⁺), so there is a possibility that the energy density of a lithium-ion battery can exceed about 250 Wh/kg and achieve a capacity of about 440 Wh/kg when the negative electrode is changed to lithium metal. However, due to the price of lithium, problems in the production of lithium foil, and stability issues due to high reactivity, it is difficult to apply it to battery manufacturing facilities. Therefore, there is a need for the development of a new system to solve the problems with using lithium.

A method to significantly increase the capacity of the negative electrode while using the current battery manufacturing equipment as it is, is to induce lithium electrodeposition in internal pores inside the graphite or voids between graphite particles, thereby utilizing the capacity of lithium along with the capacity of graphite. For this purpose, if the battery is designed and charged with a capacity larger than the theoretical capacity of graphite, 372 mAh/g, for example, about 700 to 800 mAh/g, after the graphite charging is completed at about 0.1V (vs. Li/Li⁺), through lithium electrodeposition, it is possible to secure a capacity approximately twice that of graphite. However, in this case, lithium is deposited as dendrites on the surface of the graphite negative electrode rather than being deposited inside the graphite. In this case, lithium may penetrate the separator and reach the positive electrode, which can cause serious safety accidents such as fires and explosions in the battery. In addition, when using a commercial electrolyte including lithium salts such as LiPF₆ and carbonate-based solvents, the electrolyte reacts with lithium metal due to its low reversibility and is continuously decomposed and depleted, resulting in a rapid decrease in battery capacity.

### SUMMARY OF THE INVENTION

By charging, lithium is not electrodeposited as a dendrite on the upper end of the carbon material negative electrode plate, but is successfully electrodeposited inside the carbon material negative electrode to provide a hybrid negative electrode that can achieve a capacity of about 400 mAh/g or more by combining carbon material and lithium, and a high-concentration electrolyte system that makes this possible is incorporated to provide a rechargeable lithium battery with high capacity, high energy density, and long cycle-life characteristics and secured safety.

In an embodiment, a rechargeable lithium battery includes a positive electrode, a negative electrode, a separator between the positive electrode and the negative electrode, and an electrolyte, wherein the negative electrode includes a negative electrode current collector and a negative electrode active material layer on the negative electrode current collector, the negative electrode active material layer includes a carbon material capable of intercalating and deintercalating lithium as a negative electrode active material, the negative electrode further includes a lithiophilic element on the surface of the negative electrode current collector and/or inside the negative electrode active material layer, the lithiophilic element includes one or more elements selected from Al, Ag, Au, Bi, In, Mg, Pd, Pt, Si, Sn, and Zn, the negative electrode is one in which lithium is electrodeposited between the negative electrode current collector and the negative electrode active material layer and/or inside the negative electrode active material layer by charging, the electrolyte includes an organic solvent and a lithium salt, the organic solvent includes about 50 vol % or more of an ether-based solvent, and a concentration of the lithium salt is about 3 M to about 5 M.

According to an embodiment, the hybrid negative electrode for a rechargeable lithium battery can achieve a capacity of greater than or equal to about 400 mAh/g by successfully electrodepositing lithium inside the carbon material negative electrode by charging, thereby realizing reversible capacity by the carbon material together with lithium. A rechargeable lithium battery according to an embodiment incorporates a high-concentration electrolyte system that enables an operation of such a negative electrode system, and may realize very high capacity while realizing high energy density, high output charge and discharge, and long cycle-life characteristics, and ensures safety.

### BRIEF DESCRIPTION OF THE DRAWINGS

FIG. 1 is a conceptual view schematically showing a conventional negative electrode form (left) in which lithium is electrodeposited on the upper end of a carbon material negative electrode plate and a negative electrode structure in which lithium is electrodeposited into the inside of a carbon material negative electrode according to an embodiment.

FIG. 2 shows a scanning electron microscope (SEM) image of the cross-section of the negative electrode of Example 1 before charging and discharging.

FIG. 3 is an image of element mapping using Energy Dispersive X-ray Spectroscopy (EDS) in FIG. 2.

FIG. 4 is an SEM image of the cross-section of the negative electrode taken after charging the battery cell of Comparative Example 1 to 700 mAh/g.

FIG. 5 is an image of element mapping in FIG. 4 by EDS.

FIG. 6 is an SEM image of the cross-section of the negative electrode taken after charging the battery of Example 1 to 700 mAh/g.

FIG. 7 is an image of element mapping in FIG. 6 by EDS.

FIG. 8 is a graph showing cycle-life characteristics of the battery cells of Examples 1 to 3 and Comparative Example 1 and showing the specific discharge capacity according to the number of cycles.

FIG. 9 is a graph showing cycle-life characteristics of the battery cells of Examples 1 to 3 and Comparative Example 1 and showing coulombic efficiency according to the number of cycles.

FIG. 10 shows a negative electrode plate charging voltage profiles for the battery cells of Comparative Example 2, Comparative Example 3, Example 4, Example 1, and Example 5.

FIG. 11 shows dQ/dV graphs according to voltage for the battery cells of Comparative Example 2, Comparative Example 3, Example 4, Example 1, and Example 5.

FIG. 12 shows physical photographs of the negative electrodes taken after charging the battery cells of Comparative Example 2, Comparative Example 3, Example 4, Example 1, and Example 5 to 700 mAh/g.

FIG. 13 is a SEM-EDS elemental mapping image of the cross-section of the negative electrode taken after charging the battery cell of Example 4 to 700 mAh/g.

FIG. 14 is a SEM-EDS elemental mapping image of the cross-section of the negative electrode taken after charging the battery of Example 1 to 700 mAh/g.

FIG. 15 is a SEM-EDS elemental mapping image of the cross-section of the negative electrode taken after charging the battery cell of Example 5 to 700 mAh/g.

### DETAILED DESCRIPTION OF THE EMBODIMENTS

Hereinafter, specific embodiments will be described in detail so that those skilled in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by a transmission electron microscopic photograph or a scanning electron microscopic photograph. Alternatively, it is possible to obtain an average particle diameter value by measuring it using a dynamic light scattering method, performing data analysis, counting the number of particles for each particle size range, and calculating from this. As used herein, when a definition is not otherwise provided, the average particle diameter may mean a diameter (D50) of particles having a cumulative volume of 50 vol % in a particle size distribution.

Herein, “or” is not to be construed as an exclusive meaning, for example, “A or B” is construed to include A, B, A+B, and the like.

### Rechargeable Lithium Battery

In an embodiment, a negative electrode for a rechargeable lithium battery includes a negative current collector, and the a negative electrode active material layer on the negative electrode current collector, the negative electrode active material layer includes a carbon material capable of intercalating and deintercalating lithium as a negative electrode active material, the negative electrode includes a lithiophilic element on the surface of the negative electrode current collector and/or inside the negative electrode active material layer, the lithiophilic element includes one or more elements selected from Al, Ag, Au, Bi, In, Mg, Pd, Pt, Si, Sn, and Zn, the negative electrode is one in which lithium is electrodeposited between the negative electrode current collector and the negative electrode active material layer and/or inside the negative electrode active material layer by charging. In this negative electrode, both the carbon material and the electrodeposited lithium implement reversible capacity, and thus a specific capacity of greater than or equal to about 400 mAh/g, for example, about 400 mAh/g to about 1000 mAh/g, about 500 mAh/g to about 1000 mAh/g, or about 600 mAh/g to about 1000 mAh/g can be achieved.

In addition, an embodiment provides a rechargeable lithium battery including a positive electrode, the aforementioned negative electrode, a separator between the positive electrode and the negative electrode, and an electrolyte. The electrolyte enables the operation of the aforementioned negative electrode system and includes an organic solvent and a lithium salt, the organic solvent includes about 50 vol % or more of an ether-based solvent, and a concentration of the lithium salt is about 3 M to about 5 M. The electrolyte according to an embodiment may be referred to high-concentration electrolyte. This rechargeable lithium battery includes a new hybrid negative electrode that realizes very high capacity, thereby realizing high capacity, high energy density, high output characteristics, and long cycle-life characteristics, and ensuring battery safety.

The negative electrode according to an embodiment includes a lithiophilic element, which is a type of catalyst. Accordingly, in the nucleation stage when electrodeposition of lithium begins after completion of carbon material charging, lithium nuclei, which can determine a location of lithium electrodeposition, are formed inside the negative electrode active material layer or on the lithiophilic element (e.g., catalyst metal) on the surface of the negative electrode current collector, allowing lithium to be successfully electrodeposited inside the negative electrode plate. The negative electrode according to an embodiment may be referred to a type of hybrid negative electrode because both the carbon material negative electrode active material and the electrodeposited lithium implement reversible capacity. For example, it may be referred to a carbon material-lithium hybrid negative electrode, or a graphite-lithium hybrid negative electrode.

However, when an organic electrolyte such as a general carbonate-based electrolyte is applied to such a hybrid negative electrode, lithium cannot sufficiently enter the inside of the negative electrode and is electrodeposited on the upper end of the negative electrode plate, and a side reaction occurs between the electrodeposited lithium metal and the organic electrolyte, depleting the electrolyte and causing rapidly decreased capacity, and additionally, lithium electrodeposited on the upper end of the negative electrode plate grows into dendrites and touches the positive electrode, causing a battery explosion or fire. In an embodiment, in order to solve this problem and successfully introduce the hybrid negative electrode into a rechargeable lithium battery, first, by increasing the concentration of lithium salt to a certain range, lithium is induced to be electrodeposited inside the electrode plate rather than on the upper end of the hybrid negative electrode, and second, second, by applying an electrochemically stable ether-based solvent with low reactivity to lithium metal and high reduction resistance and selectively introducing a negative electrode protective film-forming additive, high capacity may be preserved and long cycle-life characteristics may be secured. In other words, a hybrid negative electrode is successfully introduced into a rechargeable lithium battery by applying a high-concentration lithium salt and ether-based solvent electrolyte system.

### Negative Electrode

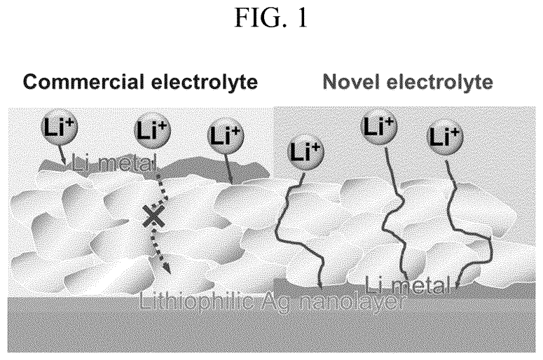

FIG. 1 is a schematic view of a negative electrode system. A left view of FIG. 1 shows a conventional art using a general electrolyte solution, in which when lithium is charged to a larger ion capacity than graphite to electrodeposit the lithium inside a carbon material after introducing a lithiophilic (Ag) element into a graphite negative electrode, the lithium is substantially electrodeposited only on a negative electrode plate. A right view of FIG. 1 shows that the lithium is successfully electrodeposited inside the carbon material by applying a negative electrode and an electrolyte system according to an embodiment. FIG. 1 shows a structure of forming a silver-containing coating layer on the surface of a current collector, but elements other than the silver may be applied thereto, and the lithiophilic elements such as silver and the like may be dispersed inside the carbon material active material layer or present as a layer.

In the negative electrode according to an embodiment, the negative electrode active material includes a carbon material capable of reversible intercalating and deintercalating lithium. This carbon material is a material that realizes capacity on its own, and are distinguished from amorphous carbon such as carbon black. For example, it may be crystalline carbon. The crystalline carbon is a material that realizes capacity by enabling reversible intercalation and deintercalation of lithium. It is in a form of particles, enabling electrodeposition of lithium in voids between particles, and also enables electrodeposition of lithium in pores inside the particles. The crystalline carbon may be spherical, plate-shaped, shapeless, flake-shaped, or fibrous. The crystalline carbon may specifically be graphite, and may be natural graphite or artificial graphite.

In an embodiment, spherical graphite particles may be included as the negative electrode active material. Since the spherical graphite particles themselves have theoretical capacity of about 372 mAh/g and sufficiently secure voids among themselves, lithium in a large amount may be electrodeposited in the voids by charging and in addition, since the particles have a plurality of pores inside, the lithium may be electrodeposited onto the internal pores of particles, which confirms that the spherical graphite particles are excellent for constructing a carbon material-lithium hybrid negative electrode. The negative electrode for a rechargeable lithium battery according to an embodiment including the spherical graphite particles as the negative electrode active material and the lithiophilic element inside the active material layer or on the current collector surface may achieve specific capacity of about 400 mAh/g or more, as both graphite and lithium realize reversible capacity, and even specific capacity of about 700 to about 800 mAh/g or about 1000 mAh/g according to capacity of a positive electrode.

In an embodiment, an average particle diameter (D50) of the carbon material particles used as the negative electrode active material may be, for example, about 1 μm to about 50 μm, for example, about 1 μm to about 40 μm, about 1 μm to about 30 μm, about 1 μm to about 25 μm, about 1 μm to about 20 μm, about 2 μm to about 50 μm, about 5 μm to about 50 μm, about 10 μm to about 50 μm, about 15 μm to about 50 μm, or the like. When a carbon material having a particle diameter within the ranges is used, since energy density may not only be increased, but also sufficient voids among particles may be secured, lithium capacity according to lithium electrodeposition may be maximized. Herein, the average particle diameter may be obtained by randomly selecting 20 carbon material particles in an electron microscope image of an electrode to measure a particle diameter and taking a diameter (D50) of the particles at a cumulative volume of 50 vol % in a particle distribution.

In the negative electrode for a rechargeable lithium battery according to an embodiment, the location at which lithium is electrodeposited by charging is (i) between the negative electrode current collector and the negative electrode active material layer, (ii) voids between the carbon material particles, and/or (iii) pores inside the carbon material particles. It may be electrodeposited in one or more of three locations, or it may be electrodeposited in all three locations. This negative electrode has a wide and sufficient space for lithium to be electrodeposited, thereby maximizing capacity due to lithium.

The negative electrode active material layer may include other negative electrode active materials in addition to the aforementioned carbon material. For example, the negative electrode active material layer may further include a silicon-based negative electrode active material and/or a tin-based negative electrode active material. In this case, the capacity of the negative electrode can be maximized.

The silicon-based negative electrode active material may be, for example, silicon, silicon-carbon composite, silicon oxide (SiOₓ; 0<x≤2), a Si-Q alloy (wherein Q is one or more elements selected from an alkali metal, an alkaline-earth metal, a Group 13 element, a Group 14 element, a Group 15 element, a Group 16 element, a transition metal, and a rare earth element silicon, but not silicon), or a combination thereof.

The tin-based negative electrode active material may be, for example, tin, tin oxide (e.g., SnO₂), a Sn—R alloy (wherein R is one or more elements selected from an alkali metal, an alkaline-earth metal, a Group 13 element, a Group 14 element, a Group 15 element, a Group 16 element, a transition metal, and a rare earth element silicon, but not tin), or a combination thereof, and at least one of these may be mixed with SiO₂. The elements Q and R may include, for example, at least one selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, and Po.

The silicon-based negative electrode active material and/or tin-based negative electrode active material may be included in an amount of about 0 wt % to about 60 wt %, about 1 wt % to about 50 wt %, about 1 wt % to about 40 wt %, about 1 wt % to about 30 wt %, or about 5 wt % to about 20 wt % based on 100 wt % of the negative electrode active material in the negative electrode active material layer. In this case, high capacity can be achieved while reducing costs.

A content of the negative electrode active material in the negative electrode active material layer may be about 80 wt % to about 100 wt %, for example about 85 wt % to about 99 wt %, about 90 wt % to about 99 wt %, or about 95 wt % to about 98 wt % based on a total weight of the negative electrode active material layer.

The positive electrode active material layer may optionally include a binder and/or a conductive material in addition to the negative electrode active material. The binder may be included in an amount of about 0.1 wt % to about 10 wt %, for example about 0.5 wt % to about 5 wt %, or about 1 wt % to about 3 wt % based on 100 wt % of the negative electrode active material layer. The conductive material may be included in an amount of about 0.1 wt % to about 10 wt %, for example about 0.5 wt % to about 5 wt %, or about 1 wt % to about 3 wt % based on 100 wt % of the negative electrode active material layer.

The binder serves to attach the negative electrode active material particles to each other and attach the negative electrode active material to the current collector. The binder may include a water-insoluble binder, a water-soluble binder, or a combination thereof.

The water-insoluble binder may include polyvinyl chloride, polyvinyl fluoride, a polymer containing ethylene oxide, ethylene-propylene copolymer, polystyrene, polyvinylpyrrolidone, polyurethane, polytetrafluoroethylene, polyvinylidene fluoride, polyethylene, polypropylene, polyamideimide, polyimide, copolymers thereof, or a combination thereof.

The water-soluble binder may be a rubber-based binder or a polymer resin binder. The rubber-based binder may include, for example, a styrene-butadiene rubber, an acrylated styrene-butadiene rubber, an acrylonitrile-butadiene rubber, an acrylic rubber, a butyl rubber, a fluorine rubber, or a combination thereof. The polymer resin binder may include, for example, polyethylene oxide, polyvinylpyrrolidone, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

When using a water-soluble binder, a thickener that provides viscosity may be used together, and the thickener may be, for example, a cellulose-based compound. The cellulose-based compound may include, for example, carboxymethyl cellulose, hydroxypropylmethyl cellulose, methyl cellulose, alkali metal salts thereof, or a combination thereof. The alkali metal may be Li, Na, K, etc. The thickener may be included in an amount of about 0.1 wt % to about 3 wt %, or about 0.1 wt % to about 1.5 wt % based on 100 wt % of the negative electrode active material layer.

The conductive material may be a material that provides conductivity to the electrode, and may include, for example, a carbon-based material such as natural graphite, artificial graphite, carbon black, acetylene black, Ketjen black, carbon fiber, a carbon nanofiber, and a carbon nanotube; a metal-based material in powder or fiber form including copper, nickel, aluminum, silver, etc.; a conductive polymer such as a polyphenylene derivative; or a combination thereof.

A thickness of the negative electrode active material layer is not particularly limited, but may be about 20 μm to about 500 μm, for example, about 20 μm to about 300 μm, about 20 μm to about 200 μm, or about 30 μm to about 100 μm depending on the purpose or standard.

The lithiophilic element is a type of catalyst that induces lithium to be electrodeposited into the carbon material negative electrode by charging, and may be called a catalyst metal. Herein, metal is a concept that includes a general metal, a transition metal, and a semi-metal. The lithiophilic element includes one or more elements selected from Al, Ag, Au, Bi, In, Mg, Pd, Pt, Si, Sn, and Zn, for example, Ag, Au, Mg, Zn or a combination thereof.

The lithiophilic element may be dispersed inside the negative electrode active material layer in powder form, particle form, or nucleation form. It may exist, for example, in the form of nano-sized particles of about 1 nm to about 500 nm, or may exist in the form of a kind of layer inside the negative electrode active material layer.

The lithiophilic element may be included in an amount of about 0.1 wt % to about 10 wt %, for example about 0.1 wt % to about 8 wt %, about 0.1 wt % to about 5 wt %, or about 0.5 wt % to about 3 wt % based on 100 wt % of the negative electrode active material layer. When a lithiophilic element is included in the above content range, electrodeposition of lithium into the carbon material negative electrode can be successfully induced without reducing capacity or causing side reactions.

For example, the negative electrode may include a coating layer disposed on the surface of the negative electrode current collector and including the lithiophilic element. A thickness of the coating layer including the lithiophilic element may be, for example, about 5 nm to about 1 μm, about 10 nm to about 900 nm, about 50 nm to about 800 nm, about 100 nm to about 800 nm, or about 200 nm to about 700 nm. When a coating layer containing lithium element with the above thickness range is formed on the surface of the negative electrode current collector, lithium electrodeposition can be successfully induced into the carbon material negative electrode or between the current collector and the active material layer without affecting a volume of the battery.

In the negative electrode according to an embodiment, the current collector is not particularly limited, but may be, for example, a copper foil, a nickel foil, a stainless steel foil, a titanium foil, or a polymer substrate coated with a conductive metal.

### Electrolyte

According to an embodiment, the high-concentration electrolyte of about 3 M to about 5 M increases a concentration of lithium cations around the negative electrode, effectively suppressing depletion of cations around the negative electrode during charging, and lithium may be induced to be electrodeposited on the inside of the negative electrode active material layer or on the surface of the negative electrode current collector, rather than on the upper surface of the negative electrode active material layer during charging.

The electrolyte includes about 50 vol % or more of an ether-based solvent as an organic solvent. If only a carbonate-based solvent is used as in a conventional rechargeable lithium battery, the electrolyte may react with lithium metal and continue to decompose and be depleted, resulting in a rapid decrease in the capacity of the rechargeable lithium battery and a significant decrease in cycle-life characteristics, and thus a hybrid negative electrode cannot be applied. On the other hand, the ether-based solvent has low reactivity to lithium metal and high reduction resistance, and thus may be electrochemically stable and suitable for application to the hybrid negative electrode.

However, if an excessive amount of ether-based solvent is used, the carbon material particles, which are the negative electrode active material, may be destroyed, greatly increasing a thickness of the negative electrode, and the carbon material particles may not be properly charged with lithium. This is understood as the ether-based solvent dissolving lithium ions to form a solvation shell, and the lithium and the ether-based solvent are intercalated together into the layered structure of graphite (co-intercalation), resulting in destruction (exfoliation) of the layered structure of graphite. The ether-based solvent has a relatively high donor number (DN), and thus it tends to strongly capture and solvate lithium cations. As a result, it is understood that de-solvation, which releases lithium cations from the surface of the negative electrode, does not occur, and a phenomenon of intercalation into the negative electrode along with lithium occurs. The donor number is a quantitative measure of Lewis basicity, is defined as an absolute value of the enthalpy value for the reaction of SbCl₅, a standard Lewis acid, and the Lewis base to be measured in a diluted solution of 1,2-dichloroethane, a non-coordinating solvent having a donor number of 0, and its unit is kcal/mol. The donor number of the ether-based solvent is much higher than that of generally used carbonate-based solvents. For example, ethylene carbonate (EC), a high dielectric constant cyclic carbonate that contributes most to the solvation of lithium cations among carbonate-based solvents, has a donor number of 16.4 and the donor number of dimethoxyethane (DME) is 24.0, which is a much larger value. It is understood that the ether-based solvent such as DME, which has such a high donor number, strongly capture lithium cations, cannot release lithium from the negative electrode surface, and are intercalated into the negative electrode active material, destroying the negative electrode active material.

However, in an embodiment, by controlling the concentration of lithium salt to about 3 M to about 5 M while using more than about 50 vol % or more of the ether-based solvent and optionally using additives, lithium may be effectively electrodeposited without destroying the carbon material to optimize the hybrid negative electrode system. When the concentration of lithium salt is low, less than about 3 M, a structure is formed in which the solvent solvates lithium cations, which is called SSIP (solvent-separated ion pairs). On the other hand, as the concentration increases, the amount of anions cannot be ignored, and one or two anions participate in the solvation structure, which is called contact ion pairs (CIP). Herein, structures in which more anions participate in solvation are called AGGs (aggregates). In the concentration range of about 3 M to about 5 M according to an embodiment, a CIP or AGGs structure appears, and de-solvation to separate the lithium cation and the solvent becomes easier compared to SSIP, and accordingly, a phenomenon in which the ether-based solvent intercalates with the lithium cation into the negative electrode active material (co-intercalation) is suppressed, and it becomes possible to transfer only the lithium cation into the negative electrode. In addition, by designing it at a high concentration of about 3 M to about 5 M, a high concentration of lithium cations is present around the negative electrode active material, effectively suppressing the depletion of lithium cations around the negative electrode during charging, and ultimately leading to electrodeposition of lithium inside the negative electrode.

In the electrolyte, the organic solvent may include about 50 vol % or more, for example, about 60 vol % or more, about 70 vol % or more, about 80 vol % or more, or about 90 vol % or more, and about 100 vol % or less, or about 95 vol % or less of an ether-based solvent.

The ether-based solvent may include, for example, dimethoxyethane, dibutyl ether, tetraglyme, diglyme, 2-methyltetrahydrofuran, tetrahydrofuran, or a combination thereof. In an embodiment, the ether-based solvent may be an acyclic ether-based solvent, for example, dimethoxyethane, dibutyl ether, tetraglyme, diglyme, or a combination thereof.

In addition to the ether-based solvent, the organic solvent may further include a carbonate-based solvent, an ester-based solvent, a ketone-based solvent, an alcohol-based solvent, an aprotic solvent, or a combination thereof. For example, the organic solvent may include about 50 vol % to about 100 vol % of the ether-based solvent; and about 0 vol % to about 50 vol % of the carbonate-based solvent, ester-based solvent, ketone-based solvent, alcohol-based solvent, aprotic solvent, or combination thereof.

The carbonate-based solvent may include chain carbonate, cyclic carbonate, or a combination thereof. The chain carbonate may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), or a combination thereof. The cyclic carbonate may include, for example, ethylene carbonate (EC), propylene carbonate (PC), butylene carbonate (BC), vinylene carbonate (VC), or a combination thereof. Additionally, the cyclic carbonate may include a cyclic carbonate substituted with a functional group such as a halogen group, a cyano group, or a nitro group. For example, the functional group-substituted cyclic carbonate may be fluoroethylene carbonate, difluoroethylene carbonate, chloroethylene carbonate, dichloroethylene carbonate, bromoethylene carbonate, dibromoethylene carbonate, nitroethylene carbonate, cyanoethylene carbonate, or a combination thereof.

The ester-based solvent may include, for example, methyl acetate, ethyl acetate, n-propyl acetate, dimethyl acetate, methyl propionate, ethyl propionate, γ-butyrolactone, decanolide, valerolactone, valonolactone, caprolactone, or a combination thereof.

The ketone-based solvent may include cyclohexanone, and the like. Additionally, the alcohol-based solvent may be ethyl alcohol, isopropyl alcohol, or a combination thereof. The aprotic solvent may include nitriles such as R—CN (wherein R is a hydrocarbon group having 2 to 20 carbon atoms and may include a double bond, aromatic ring, and/or ether bond), dimethylformamide, and the like. amides, dioxolanes such as 1,3-dioxolane, and sulfolanes.

In an embodiment, the electrolyte may include a lithium salt, for example LiPF₆, LiBF₄, LiSbF₆, LiClO₄, LiAlO₂, LiAlCl₄, LiCl, LiI, LiN(SO₂F)₂ (lithium bis(fluorosulfonyl)imide; LiFSI), LiN(SO₂CF₃)₂ (lithium bis(trifluoromethanesulfonyl)imide; LiTFSI), LiN(SO₂C₂F₅)₂ (lithium bis(pentafluoroethanesulfonyl)imide; LiBETI), LiSO₃CF₃ (LiOTf), LiSO₃C₄F₉, LiB(C₂O₄)₂ (lithium bis(oxalato)borate; LiBOB), LiBF₂(C₂O₄) (lithium difluoro(oxalato)borate; LiFOB), LiPF₄(C₂O₄) (lithium difluorobis(oxalato)phosphate; LiDFBP), LiPF₄(C₂O₄) (lithium tetrafluoro(oxalato)phosphate; LiTFOP), LiPO₂F₂, or a combination thereof.

In an embodiment, the lithium salt may be an imide-based lithium salt, and may include, for example, LiFSI, LiTFSI, LiBETI, or a combination thereof. If the electrolyte includes an imide-based lithium salt, ion conductivity of the electrolyte and the affinity for lithium may be increased. For example, a high concentration of lithium cations may be located around the negative electrode active material, and thus it is possible to effectively induce lithium to be electrodeposited inside the negative electrode active material layer or between the negative electrode active material layer and the current collector, rather than on the upper end of the negative electrode active material layer.

The concentration of the lithium salt in the electrolyte about 3 M to about 5 M. The concentration means about 3 M or more and about 5 M or less. For example, the concentration of the lithium salt may be greater than about 3 M and less than about 5 M, and may be about 3.1 M to about 4.9 M, about 3.5 M to about 4.5 M, or about 3.5 M to about 4.0 M. When the concentration of the lithium salt is lower than about 3 M, the concentration of lithium cations around the negative electrode is low, which may cause a problem of lithium dendrites growing at the upper end of the negative electrode. In addition, if the concentration of lithium salt is higher than about 5 M, the viscosity of the electrolyte increases excessively, and ion conductivity decreases accordingly, which may result in the formation of lithium dendrites at the upper end of the negative electrode. An embodiment can be said to optimize the hybrid negative electrode system by appropriately designing the lithium salt concentration of the electrolyte.

The electrolyte may further include a nitrogen-based additive in addition to the organic solvent and lithium salt. The nitrogen-based additive may be referred to a type of lithiophilic nitrogen-based compound or a lithiophilic nitrogen-based ionic additive.

The nitrogen-based additive may form a stable Li₃N-based film on the surface of the negative electrode active material, thereby suppressing decomposition of the carbon material negative electrode active material. In addition, at around 0.0 V of the negative electrode potential, in the strong reducing atmosphere of lithium, the nitrogen-based additive forms a Li₃N-based film only on lithium, thereby improving the morphology of lithium electrodeposition and, for example, leading to electrodeposition of lithium in a round shape rather than a dendrite phase and also, improving reversibility of electrodeposition and desorption of lithium and efficiency.

The nitrogen-based additive may include, for example, LiNO₃, KNO₃, NaNO₃, Zn(NO₃)₂, Mg(NO₃)₂, AgNO₃, Li₃N, C₃H₄N₂, or a combination thereof. The nitrogen-based additive may be included in an amount of about 0.1 wt % to about 10 wt %, for example about 0.1 wt % to about 8 wt %, about 0.1 wt % to about 6 wt %, or about 1 wt % to about 5 wt % based on 100 wt % of the electrolyte. When the nitrogen-based additive is included in the above content range, the electrolyte can maintain an appropriate viscosity while maintaining high ion conductivity and lithiophilic properties, and the morphology of electrodeposited lithium is improved, thereby improving the efficiency of a rechargeable lithium battery using a hybrid negative electrode according to an embodiment. and improving cycle-life characteristics.

The electrolyte according to an embodiment may further include a fluorine-based additive in addition to the aforementioned organic solvent and lithium salt. The fluorine-based additive may be referred to a type of fluorine-donor (F-donor) type compound or a fluorine-containing ionic additive. The fluorine-based additive is decomposed at a negative electrode potential of about 1.8 V (vs Li/Li⁺) to form a stable film including LiF and organic components on the surface of the carbon negative electrode active material layer. Accordingly, not only does it suppress the decomposition of the carbon negative electrode active material, but it also decomposes before the nitrogen-based additive to form a film, thereby suppressing precipitation of lithium on the surface of the negative electrode active material layer due to the nitrogen-based additive, and thus lithium can be induced to be electrodeposited inside the negative electrode active material layer or on the surface of the current collector. For example, a film due to the fluorine-based additive is first formed on the surface of the negative electrode active material layer, thereby suppressing the Li₃N-based film due to the nitrogen-based additive from being formed directly on the surface of the carbon material negative electrode active material layer, and accordingly, effectively suppressing the precipitation of lithium on the surface of the positive electrode active material layer by the nitrogen-based film.

When the electrolyte further includes a nitrogen-based additive and a fluorine-based additive, a fluorine-containing film may be formed on the surface of the negative electrode active material layer through charging and discharging, and a nitrogen-containing film may be formed thereon. This sequential film effectively induces electrodeposition of lithium inside the active material layer or on the surface of the current collector while suppressing the decomposition of the carbon negative electrode active material, thereby improving the efficiency and cycle-life characteristics of a rechargeable lithium battery using a hybrid negative electrode according to an embodiment.

The fluorine-based additive may be a compound including fluorine, for example, LiBF₂(C₂O₄) (lithium difluoro(oxalato)borate; LiFOB), LiPF₂(C₂O₄)₂ (lithium difluorobis(oxalato)phosphate; LiDFBP), LiPF₄(C₂O₄) (lithium tetrafluoro(oxalato)phosphate; LiTFOP), LiPO₂F₂, lithium fluoromalonato(difluoro)borate (LiFMDFB), lithium methylfluoromalonato(trifluoro) phosphate (LiMFMDFP), lithium methylfluoromalonato(difluoro)borate (LiMFMDFB), lithium ethylfluoromalonato(difluoro)borate (LiEFMDFB), lithium bis(fluoromalonato)borate (LiBFMB), lithium bis(methylfluoromalonato)borate (LiBMFMB), fluoroethylene carbonate (FEC), difluoroethylene carbonate (DFEC), LiPF₆, LiBF₄, LiSbF₆, or a combination thereof.

As an example, the fluorine-based additive may be a cyclic fluorine-based additive, or may be a compound having a structure having a pentagonal ring or a hexagonal ring and one or two rings. These cyclic fluorine-based additives may be, for example, LiFOB, LiDFBP, LiTFOP, LiFMDFB, LiMFMDFB, LiEFMDFB, LiBFMB, LiBMMFB, FEC, DFEC, or a combination thereof. The cyclic fluorine-based additive is advantageous in forming a film on the surface of the negative electrode, and can effectively induce lithium to be electrodeposited inside the negative electrode rather than on the negative electrode surface while suppressing decomposition of the carbon negative electrode active material.

The fluorine-based additive may be included in an amount of about 0.1 wt % to about 10 wt %, for example, about 0.1 wt % to about 8 wt %, about 0.1 wt % to about 6 wt %, about 0.1 wt % to about 5 wt %, or about 0.5 wt % to about 3 wt % based on 100% by weight of the electrolyte. When the fluorine-based additive is included in the above content range, electrodeposition of lithium inside the negative electrode active material layer or on the surface of the current collector can be effectively induced by charging, and thus the efficiency and cycle-life characteristics of a rechargeable lithium battery using a hybrid negative electrode according to an embodiment. can be improved.

According to an embodiment, if the electrolyte further includes the fluorine-based additive, the lithium salt and the fluorine-based additive may be different compounds. For example, the lithium salt may be an imide-based lithium salt that has high ion conductivity and is lithiophilic, and may include, for example, LiFSI, LiTFSI, LiBETI, or a combination thereof, and the fluorine-based additive may be a cyclic fluorine-based additive that is advantageous for film formation and may include, for example, LiFOB, LiDFBP, LiTFOP, LiFMDFB, LiMFMDFB, LiEFMDFB, LiBFMB, LiBMMFB, FEC, DFEC, or a combination thereof. If such an imide-based lithium salt, a cyclic fluorine-based additive, and a nitrogen-based additive are used together, performance of a rechargeable lithium battery using a hybrid negative electrode may be maximized.

### Positive Electrode

The positive electrode according to an embodiment may be applied to any type as long as it is used in a rechargeable lithium battery.

The positive electrode may include a current collector and a positive electrode active material layer on the current collector. The positive electrode active material layer includes a positive electrode active material, and may optionally further include a binder and/or a conductive material.

In an embodiment, the positive electrode active material may be applied without limitation in type, and for example, a compound capable of reversible intercalation and deintercalation of lithium (lithiated intercalation compound) may be used.

For example, the positive electrode active material may be a lithium-metal composite oxide or a lithium-metal composite phosphate, and the metal may be Al, Co, Fe, Mg, Ni, Mn, V, etc. The positive electrode active material may include, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium manganese oxide (LMO), or lithium iron phosphate (LFP).

As an example, the positive electrode active material may include a lithium nickel-based composite oxide represented by Chemical Formula 1, which can realize high capacity, high energy density, etc.

Liₐ₁Niₓ₁M¹_{y1}M²_{1-x1-y1}O₂ [Chemical Formula 1]

In Chemical Formula 1, 0.9≤a1≤1.8, 0.3≤x1≤1, 0≤y1≤0.7, M¹ and M² are each independently one or more element selected from Al, B, Ba, Ca, Ce, Co, Cr, Cu, F, Fe, Mg, Mn, Mo, Nb, P, S, Si, Sr, Ti, V, W, and Zr.

In Chemical Formula 1, 0.3≤x1≤1 and 0≤y1≤0.7, 0.4≤x1≤1 and 0≤y1≤0.6, 0.5≤x1≤1 and 0≤y1≤0.5, 0.6≤x1≤1 and 0≤y1≤0.4, 0.7≤x1≤1 and 0≤y1≤0.3, 0.8≤x1≤1 and 0≤y1≤0.2, 0.85≤x1≤1 and 0≤y1≤0.15, or 0.9≤x1≤1 and 0≤y1≤0.1.

The positive electrode active material may be, for example, a high nickel-based positive electrode active material, and in this case, rechargeable lithium battery with high capacity, high output, and high energy density can be implemented. The high nickel-based positive electrode active material may have a nickel content of about 80 mol % or more, for example, about 85 mol % or more, about 89 mol % or more, about 90 mol % or more, about 91 mol % or more, or about 94 mol % or more, and about 99.9 mol % or less, or about 99 mol % or less relative to the total amount of elements excluding lithium and oxygen in the lithium nickel-based composite oxide. If the nickel content satisfies the above range, the positive electrode active material may achieve high capacity and exhibit excellent battery performance. The high nickel-based positive electrode active material that achieves such high capacity is suitable for use with the hybrid negative electrode according to an embodiment and may maximize the performance of rechargeable lithium battery.

The binder serves to well adhere the positive electrode active material particles to each other and also to adhere the positive electrode active material to the current collector. The binder may be for example polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

A content of the binder in the positive electrode active material layer may be approximately about 0.1 wt % to about 10 wt % based on a total weight of the positive electrode active material layer.

The conductive material is used to provide conductivity to the electrode, and may include, for example, a carbon-based material such as natural graphite, artificial graphite, carbon black, acetylene black, Ketjen black, a carbon fiber, a carbon nanofiber, and a carbon nanotube; a metal-based material including copper, nickel, aluminum, silver, etc. and in the form of a metal powder or a metal fiber; a conductive polymer such as a polyphenylene derivative; or a mixture thereof.

A content of the conductive material in the positive electrode active material layer may be about 0.1 wt % to about 10 wt % based on a total weight of the positive electrode active material layer.

Aluminum foil may be used as the positive electrode current collector, but is not limited thereto.

### Separator

The separator separates the positive and negative electrodes and provides a passage for lithium ions, and may be used as any type commonly used in a rechargeable lithium battery. The separator may be one that has low resistance to ion movement in the electrolyte and has excellent electrolyte impregnation ability. For example, the separator may include a glass fiber, polyester, polyethylene, polypropylene, polytetrafluoroethylene, or a combination thereof, and may be in a non-woven or woven form. For example, in a rechargeable lithium battery, a polyolefin-based polymer separator such as polyethylene and polypropylene may be mainly used, and a separator coated with a ceramic component or a polymer material may be used to ensure heat resistance or mechanical strength, and may optionally be made into a single-layer or multi-layer structure.

A rechargeable lithium battery may be classified into a lithium ion battery, a lithium polymer battery, and an all-solid-state battery depending on the type of separator and electrolyte used, and may be classified into cylindrical, prismatic, coin, pouch, etc. depending on its shape.

A rechargeable lithium battery according to an embodiment has high capacity and high energy density, has excellent storage stability, cycle-life characteristics, and high rate characteristics at high temperatures, ensures safety, and is suitable for mass production, and thus it may be used in various fields such as electric vehicles, portable electronic devices, or energy storage systems.

Hereinafter, examples and comparative examples of the present invention will be described. The following examples are only examples of the present invention, and the present invention is not limited to the following examples.

### EXAMPLE 1

The electrolyte according to Example 1 is prepared by adding 3.8 M LiFSI lithium salt to dimethoxyethane (DME) solvent.

A negative electrode is manufactured by coating silver (Ag) as a lithiophilic element on the surface of a copper current collector through sputtering, coating a composition for a negative electrode active material layer thereon, wherein the composition is prepared by mixing 96 wt % of spherical shape graphite having pellet density of about 2 mg/cm² and a particle diameter (D50) of about 17 μm, 1.5 wt % of a styrene-butadiene rubber, 1.5 wt % of carboxylmethyl cellulose, and 1 wt % of a carbon black (Super-P) conductive material in distilled water, and then, drying and compressing it.

A negative electrode active material layer obtained after the compressing has a thickness of about 20 μm, and a silver (Ag)-containing coating layer on the current collector surface has a thickness of about 500 nm.

The prepared negative electrode and a lithium metal counter electrode are used, a polyethylene separator is disposed therebetween, and the prepared electrolyte is injected thereinto to manufacture a half-cell.

### EXAMPLE 2

An electrolyte and half-cell are manufactured in the same manner as in Example 1, except that 1 wt % of lithium difluorobis(oxalato)phosphate (LiDFBP) is added based on 100 wt % of the electrolyte.

### EXAMPLE 3

An electrolyte and half-cell are manufactured in the same manner as in Example 1, except that 1 wt % of lithium difluoro(oxalato)borate (LiFOB) is added to based on 100 wt % of the electrolyte.

### EXAMPLE 5

An electrolyte and half-cell are manufactured in the same manner as in Example 1, except that the concentration of lithium salt is changed to 3M.

### EXAMPLE 6

An electrolyte and half-cell are manufactured in the same manner as in Example 1, except that the concentration of lithium salt is changed to 5 M.

### COMPARATIVE EXAMPLE 1

A half-cell is manufactured in the same manner as in Example 1, except that 1.15 M of LiPF₆ lithium salt is added to an organic solvent including a mixture of ethylene carbonate (EC), fluoroethylene carbonate (FEC), and dimethoxyethane (DME) in a volume ratio of 1:2:7 as an electrolyte.

### COMPARATIVE EXAMPLE 2

An electrolyte and half-cell are manufactured in the same manner as in Example 1, except that the concentration of lithium salt is changed to 1.15 M.

### COMPARATIVE EXAMPLE 3

An electrolyte and half-cell are manufactured in the same manner as in Example 1, except that the concentration of lithium salt is changed to 2 M.

Table 1 briefly shows that each electrolyte design of the examples and the comparative examples.

TABLE 1

| | |
|---|---|
| Comparative Example 1 | 1.15M LiPF₆ in EC/FEC/DMC |
| Example 1 | 3.8M LiFSI in DME |
| Example 2 | 3.8M LiFSI in DME + 1 wt % LiDFBP |
| Example 3 | 3.8M LiFSI in DME + 1 wt % LiFOB |
| Comparative Example 2 | 1.15M LiFSI in DME |
| Comparative Example 3 | 2M LiFSI in DME |
| Example 4 | 3M LiFSI in DME |
| Example 5 | 5M LiFSI in DME |

### Evaluation Example 1: SEM-EDS Analysis of Cross-Section of Negative Electrode after Charging

The half-cells according to Example 1 and Comparative Example 1 are charged at 0.05 C for 20 hours to 700 mAh/g, which is greater than 372 mAh/g of theoretical capacity of graphite. A scanning electron microscope (SEM) is used to take an image of a cross-section of each of the negative electrodes in a charged state, and the image is analyzed through energy dispersive x-ray spectroscopy (EDS).

On the other hand, when the charged battery cells are dissembled and put into the SEM-EDS equipment to detect lithium by detecting an oxygen (O) element through an EDS element mapping, since lithium in the battery cells is oxidized to form Li₂O and the like.

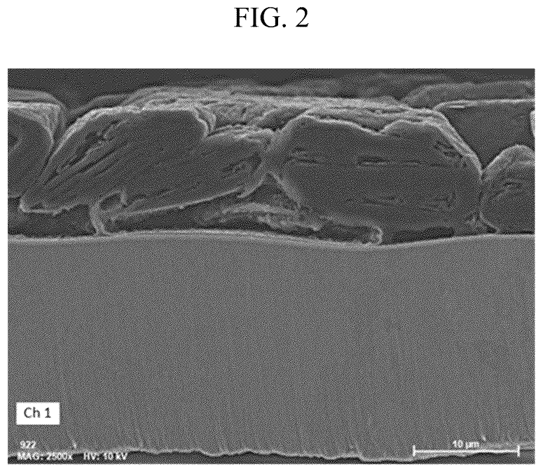

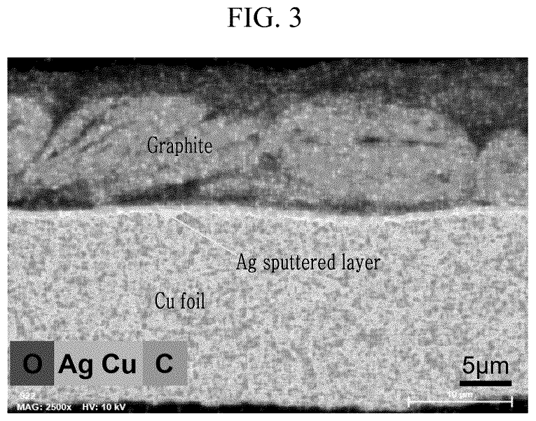

FIG. 2 is an SEM image of the cross-section of the negative electrode of Example 1, that is, the negative electrode before the charge and discharge and FIG. 3 is an element mapping image of FIG. 2 through EDS. FIGS. 2 and 3 confirm that an Ag coating layer on the copper foil current collector surface and a graphite negative electrode active material layer thereon are formed.

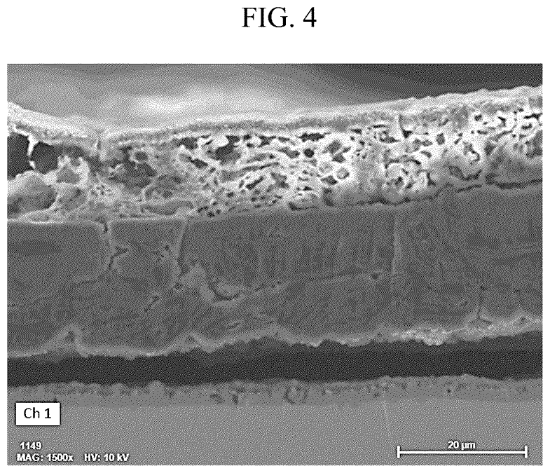

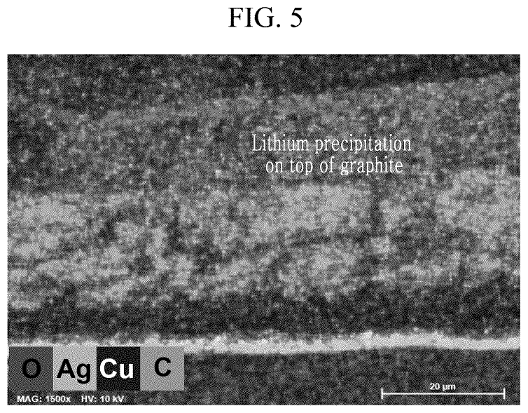

FIG. 4 is an SEM image of a cross-section of a negative electrode of the cell of Comparative Example 1 after charging it to 700 mAh/g and FIG. 5 is an element mapping image of FIG. 4 through EDS. Referring to FIGS. 4 and 5, in Comparative Example 1, lithium metal is precipitated on the upper end of the graphite negative electrode active material layer rather than electrodeposited inside the graphite negative electrode active material layer.

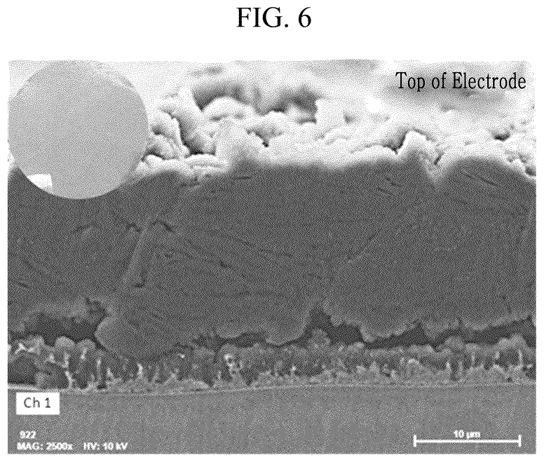

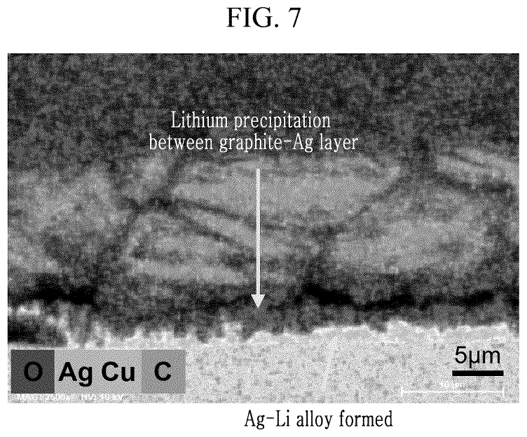

FIG. 6 is an SEM image of a cross-section of the negative electrode of the cell of Example 1 after charging it to 700 mAh/g and FIG. 7 is an element mapping image of FIG. 6 through EDS. Referring to FIGS. 6 and 7, lithium is electrodeposited inside the electrode plate, for example, between the negative active material layer and the current collector, in voids among graphite particles without the lithium precipitation on the upper end of the graphite negative electrode active material layer.

### Evaluation Example 2: Evaluation of Cycle-Life Characteristics

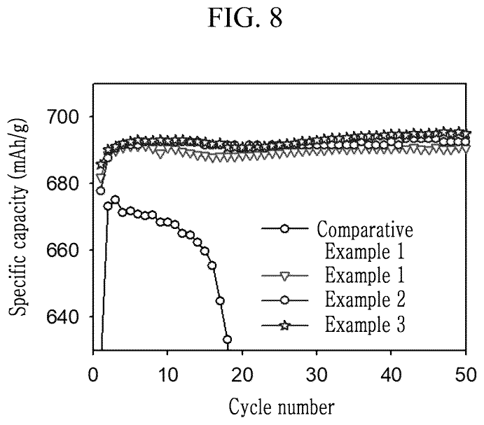

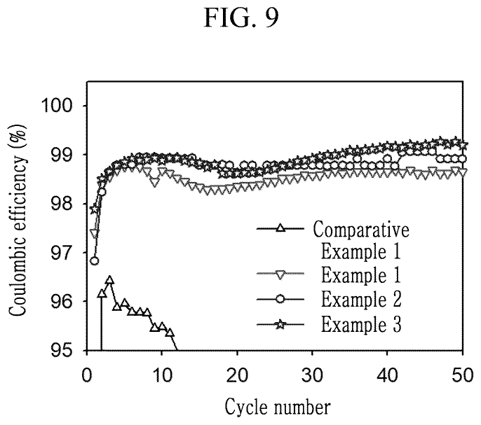

The half-cells according to Examples 1 to 3 and Comparative Example 1 are charged at 0.05 C for 20 hours, paused for 10 minutes, and discharged at 0.05 C to 1 V as an initial cycle and then, charged at 0.1 C for 10 hours, paused for 10 minutes, and discharged at 0.1 C to 1 V as a second cycle. Subsequently, the cells are 50 times or more charged and discharged at 0.5 C at 25° C. FIG. 8 shows discharge specific capacity (mAh/g) of the cells according to the number of cycles and FIG. 9 shows coulombic efficiency of the cells according to the number of cycles.

Referring to FIGS. 8 and 9, in the case of Comparative Example 1, as lithium exceeding the graphite capacity is electrodeposited on the upper end of the negative electrode active material layer, and the electrolyte is continuously reduced and decomposed on the surface of the electrodeposited lithium metal and thus depleted, the battery cycle-life expires within 20 cycles. On the contrary, Examples 1 to 3 maintain discharge capacity close to 700 mAh/g for 50 cycles or more and also coulombic efficiency of 98% or more. In particular, in Examples 2 and 3 in which fluorine-based additives are used in the electrolyte, the coulombic efficiency is found to be 99% or more. It is understood that fluorine-based additives suppress the decomposition of the electrolyte by forming a stable negative electrode protective film.

### Evaluation Example 3: Performance Evaluation According to Electrolyte Concentration

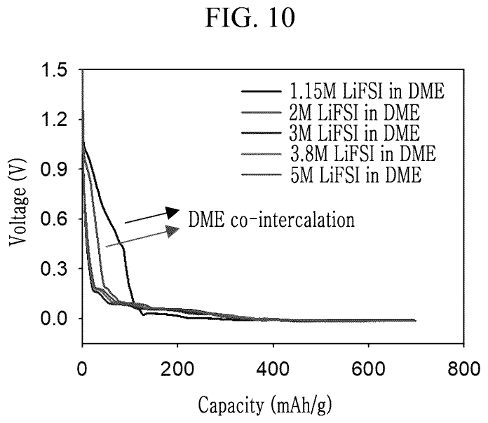

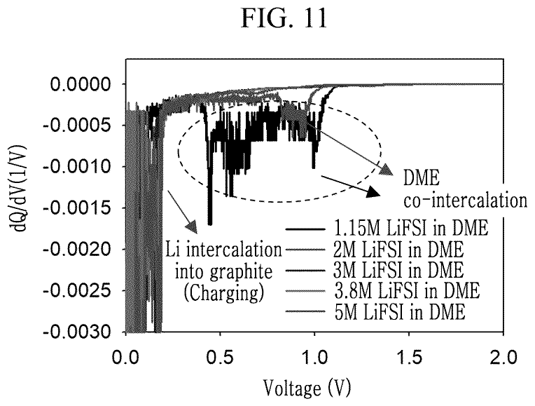

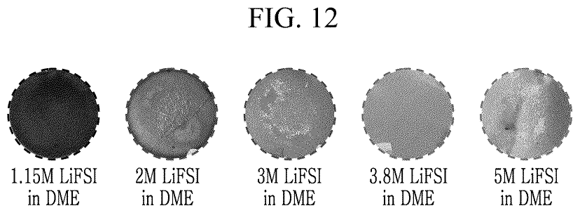

Charging voltage profiles of the negative electrode plates for the half-cells manufactured in Comparative Example 2 (1.15 M), Comparative Example 3 (2 M), Example 4 (3 M), Example 1 (3.8 M), and Example 5 (5 M) are shown in FIG. 10, dQ/dV graphs according to voltage are shown in FIG. 11, and physical photographs of the negative electrode after charging to 700 mAh/g are shown in FIG. 12.

Referring to FIGS. 10 to 12, when using a low-concentration electrolyte such as Comparative Examples 2 and 3, DME, which dissociates and dissolves lithium ion (Li⁺) to form a solvation shell, is intercalated (co-intercalated, in a region of about 0.4 V to 1.1 V in a dQ/dV graph of FIG. 11) with Li⁺ into a graphite layer to destroy the layered structure of graphite. Therefore, the electron micrograph of the negative electrode after charging shows that the spherical graphite particles are destroyed, the thickness of the negative electrode increases significantly, and as lithium is not properly charged in the graphite, there appears no golden color which is supposed to appear in graphite fully charged with lithium as shown in FIG. 12.

On the other hand, in high-concentration electrolyte systems of 3 M or more, such as Examples 1, 4, and 5, the co-intercalation phenomenon of DME does not appear in FIGS. 10 and 11, the layered structure of graphite is not destroyed, and lithium is normal properly charged in the graphite.

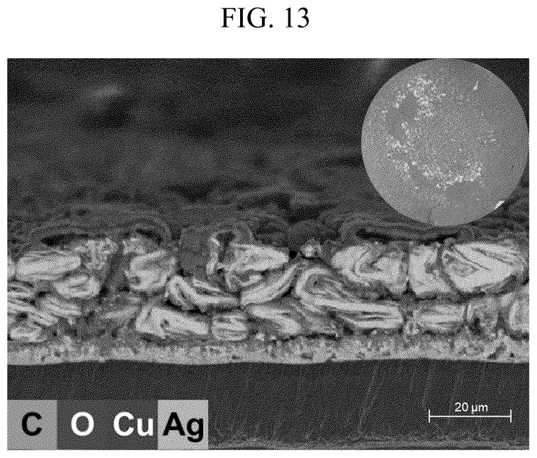

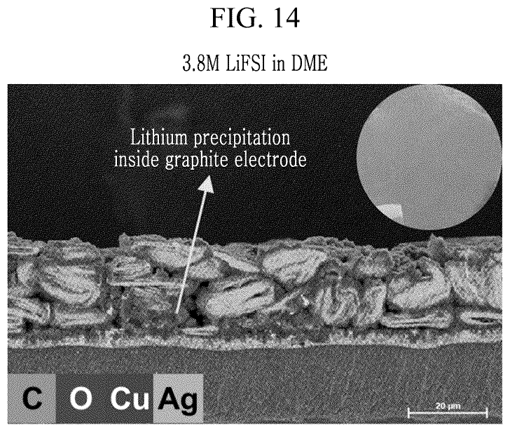

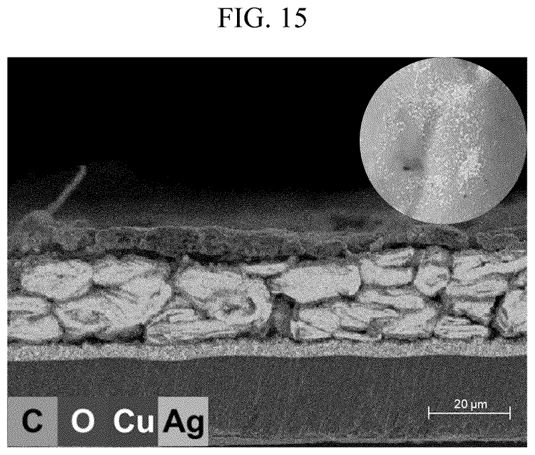

Meanwhile, the half-cells prepared in Example 4 (3 M), Example 1 (3.8 M), and Example 5 (5 M) are charged to 700 mAh/g, and then SEM-EDS analysis is performed on the cross-section of the negative electrode. The results are shown in FIGS. 13, 14, and 15 in that order. Referring to these, in the case of Example 1 of 3.8 M, lithium is very effectively electrodeposited inside the negative electrode. However, in Example 4, the concentration of cations around the negative electrode is lower than in Example 1, so lithium is electrodeposited inside the negative electrode and at the same time is partially electrodeposited on the upper end of the negative electrode. In Example 5, due to an increase in the viscosity of the electrolyte and a corresponding decrease in ion conductivity, some lithium is electrodeposited on the upper end of the negative electrode along with lithium electrodeposition inside the negative electrode. Accordingly, optimal operation of the hybrid negative electrode system is possible when applying an electrolyte with a concentration range of more than 3 M and less than 5 M.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A rechargeable lithium battery, comprising
a positive electrode, a negative electrode, a separator between the positive electrode and the negative electrode, and an electrolyte,
wherein the negative electrode includes a negative electrode current collector and a negative electrode active material layer on the negative electrode current collector, the negative electrode active material layer includes a carbon material capable of intercalating and deintercalating lithium as a negative electrode active material,
the negative electrode further includes a lithiophilic element on the surface of the negative electrode current collector and/or inside the negative electrode active material layer, the lithiophilic element includes one or more elements selected from Al, Ag, Au, Bi, In, Mg, Pd, Pt, Si, Sn, and Zn,
the negative electrode is one in which lithium is electrodeposited between the negative electrode current collector and the negative electrode active material layer and/or inside the negative electrode active material layer by charging,
the electrolyte includes an organic solvent and a lithium salt,
the organic solvent includes about 50 vol % or more of an ether-based solvent, and
a concentration of the lithium salt is about 3 M to about 5 M.

2. The rechargeable lithium battery of claim 1, wherein
in the negative electrode, the carbon negative electrode active material and the lithium electrodeposited by charging both implement capacity, and
a specific capacity of a negative electrode implemented by the carbon material negative electrode active material and electrodeposited lithium is about 400 mAh/g to about 1000 mAh/g.

3. The rechargeable lithium battery of claim 1, wherein
the carbon material capable of intercalating and deintercalating lithium as the negative electrode active material is in a form of particles, and the lithium electrodeposited by charging in the negative electrode is electrodeposited at one or more locations: (i) between the negative electrode current collector and the negative electrode active material layer, (ii) voids between the carbon material particles, and (iii) pores inside the carbon material particles.

4. The rechargeable lithium battery of claim 1, wherein
the carbon material capable of intercalating and deintercalating lithium as the negative electrode active material is in a form of particles and has an average particle diameter (D50) of about 1 μm to about 50 μm.

5. The rechargeable lithium battery of claim 1, wherein
the carbon material capable of intercalating and deintercalating lithium as the negative electrode active material is crystalline carbon having spherical shape, plate-shaped, shape-less, flake-shaped, or fibrous shape.

6. The rechargeable lithium battery of claim 1, wherein
the carbon material capable of intercalating and deintercalating lithium as the negative electrode active material is spherical graphite.

7. The rechargeable lithium battery of claim 1, wherein
the negative electrode active material layer further includes a Si-based negative electrode active material and/or a Sn-based negative electrode active material.

8. The rechargeable lithium battery of claim 1, wherein
the negative electrode active material layer has a thickness of about 20 20 μm to about 500 μm.

9. The rechargeable lithium battery of claim 1, wherein
the lithiophilic element is included in an amount of about 0.1 wt % to about 10 wt % based on 100 wt % of the negative electrode active material layer.

10. The rechargeable lithium battery of claim 1, wherein
the negative electrode includes a coating layer disposed on the surface of the negative electrode current collector and including the lithiophilic element.

11. The rechargeable lithium battery of claim 10, wherein
the coating layer including the lithiophilic element has a thickness of about nm to about 1 μm.

12. The rechargeable lithium battery of claim 1, wherein
a concentration of the electrolyte is about 3.5 M to about 4.5 M.

13. The rechargeable lithium battery of claim 1, wherein
the organic solvent in the electrolyte includes about 80 vol % or more of an ether-based solvent.

14. The rechargeable lithium battery of claim 1, wherein
in the electrolyte, the ether-based solvent includes dimethoxyethane, dibutyl ether, tetraglyme, diglyme, 2-methyltetrahydrofuran, tetrahydrofuran, or a combination thereof.

15. The rechargeable lithium battery of claim 1, wherein
the ether-based solvent in the electrolyte is an acyclic ether-based solvent.

16. The rechargeable lithium battery of claim 1, wherein
the organic solvent in the electrolyte includes
about 50 vol % to about 100 vol % of the ether-based solvent; and
about 0 vol % to about 50 vol % of a carbonate-based solvent, an ester-based solvent, a ketone-based solvent, an alcohol-based solvent, an aprotic solvent, or a combination thereof.

17. The rechargeable lithium battery of claim 1, wherein
in the electrolyte, the lithium salt includes LiPF₆, LiBF₄, LiSbF₆, LiClO₄, LiAlO₂, LiAlCl₄, LiCl, LiI, LiN(SO₂F)₂ (lithium bis(fluorosulfonyl)imide; LiFSI), LiN(SO₂CF₃)₂ (lithium bis(trifluoromethanesulfonyl)imide; LiTFSI), LiN(SO₂C₂F₅)₂ (lithium bis(pentafluoroethanesulfonyl)imide; LiBETI), LiSO₃CF₃ (LiOTf), LiSO₃C₄F₉, LiB(C₂O₄)₂ (lithium bis(oxalato)borate; LiBOB), LiBF₂ (C₂O₄, lithium difluoro(oxalato)borate; LiFOB), LiPF₂(C₂O₄)₂ (lithium difluorobis(oxalato)phosphate; LiDFBP), LiPF₄(C₂O₄) (lithium tetrafluoro(oxalato)phosphate; LiTFOP), LiPO₂F₂, or a combination thereof.

18. The rechargeable lithium battery of claim 1, wherein
the lithium salt in the electrolyte is an imide-based lithium salt including LiFSI, LiTFSI, LiBETI, or a combination thereof.

19. The rechargeable lithium battery of claim 1, wherein
the electrolyte further includes a nitrogen-based additive.

20. The rechargeable lithium battery of claim 19, wherein
the nitrogen-based additive includes LiNO₃, KNO₃, NaNO₃, Zn(NO₃)₂, Mg(NO₃)₂, AgNO₃, Li₃N, C₃H₄N₂, or a combination thereof.

21. The rechargeable lithium battery of claim 19, wherein
the nitrogen-based additive is included in an amount of about 0.1 wt % to about 10 wt % based on 100 wt % of the electrolyte.

22. The rechargeable lithium battery of claim 1, wherein
the electrolyte further includes a fluorine-based additive.

23. The rechargeable lithium battery of claim 22, wherein
the fluorine-based additive includes LiBF₂(C₂O₄) (lithium difluoro(oxalato)borate; LiFOB), LiPF₂(C₂O₄)₂ (lithium difluorobis(oxalato)phosphate; LiDFBP), LiPF₄(C₂O₄) (lithium tetrafluoro(oxalato)phosphate; LiTFOP), LiPO₂F₂, lithium fluoromalonato(difluoro)borate (LiFMDFB), lithium methylfluoromalonato(trifluoro)phosphate(LiMFMDFP), lithium methylfluoromalonato(difluoro)borate (LiMFMDFB), lithium ethylfluoromalonato(difluoro)borate (LiEFMDFB), lithium bis(fluoromalonato)borate (LiBFMB), lithium bis(methylfluoromalonato)borate (LiBMFMB), fluoroethylene carbonate (FEC), difluoroethylene carbonate (DFEC), LiPF₆, LiBF₄, LiSbF₆, or a combination thereof.

24. The rechargeable lithium battery of claim 22, wherein
the fluorine-based additive is included in an amount of about 0.1 wt % to about 10 wt % based on 100 wt % of the electrolyte.
